(19) United States
(12) Patent Application Publication
(10) Pub. No.: US 2014/0053786 A1
(43) Pub. Date: Feb. 27, 2014

(54) CAT ATTRACTION TOY

(71) Applicant: Betty Lee, San Francisco, CA (US)

(72) Inventor: Betty Lee, San Francisco, CA (US)

(73) Assignee: WORLDWISE, INC., San Rafael, CA (US)

(21) Appl. No.: 13/593,324

(22) Filed: Aug. 23, 2012

(51) Int. Cl. A01K 29/00

(52) U.S. Cl. 119/708; 119/707

(57) ABSTRACT

A cat toy having a hollow shell, a top and a bottom and a power source retained therein. A motor is also contained within the hollow shell powered by the power source and having a drive pulley emanating from it to selectively rotate a disk at its geometric center. A string-like element is appended to the selectively rotatable disk radially offset from its geometric center. The pet toy is provided with a support for hanging it from a projection such as a door knob and when in use, the string-like element is caused to move haphazardly to attract a pet cat.

### TECHNICAL FIELD

A cat attraction toy capable of amusing and occupying a domestic cat for extended periods of time without the need for significant human intervention.

### BACKGROUND OF THE INVENTION

It is well known that pet cats require stimulation. Without it they get bored which could result in health problems and associated unwelcomed anti-social behavior. It is also well known to anyone owning a pet cat that they express a natural instinct to be almost mesmerized by moving objects. This stems from their instinctual need to chase pray. As such, cat owners oftentimes dangle attractants in front of their pets observing as the pet swats and even pounces upon them. Something as simple as a dangling string could maintain the interest of a pet cat for an extended period of time. However, if one was to engage his or her pet cat in this fashion, it could get quite tedious as the cat's interest would be generally maintained only when the string was being shaken or otherwise moved.

It is thus an object of the present invention to provide a cat attraction toy which is simple to construct and operate and inexpensive to implement and yet capable of maintaining the interest of a pet cat for a prolonged period.

These and further objects will be more readily appreciated when considering the following disclosure and appended claims.

### SUMMARY OF THE INVENTION

The present invention involves a cat toy comprising a hollow shell and, in its preferred embodiment, the hollow shell is in the shape of a cat having a head portion and a body portion. A power source is placed within the hollow shell for selectively powering a motor which is also retained within the hollow shell. The motor has a drive pulley emanating therefrom and being connected to a rotatable disk located at the bottom of the hollow shell generally in the body portion opposite from the head portion when the shell is in the shape of a cat. The disk is rotatable at its geometric center and projects from the hollow shell in an opening therein. A string-like element is appended to the selectively rotatable disk in a location radially offset from its geometric center and a switch for selectively turning on the motor is made accessible on an exterior surface of the hollow shell. By activating the motor, the disk rotates causing the string-like element to move haphazardly to attract a pet cat.

### BRIEF DESCRIPTION OF THE FIGURES

FIG. 1 is a front perspective view of the present invention in its preferred embodiment.

FIG. 2 is a bottom perspective view of the present invention.

FIG. 3 is a side cut away view showing the internal components of the present invention.

### DETAILED DESCRIPTION OF THE INVENTION

Novel features which are characteristic of the invention, as to organization and method of operation, together with further objects and advantages thereof will be better understood from the following description considered in connection with the accompanying drawings, in which preferred embodiments of the invention are illustrated by way of example. It is to be expressly understood, however, that the drawings are for illustration description only and are not intended as definitions of the limits of the invention. The various features of novelty which characterize the invention are recited with particularity in the claims.

There has been broadly outlined more important features of the invention in the summary above and in order that the detailed description which follows may be better understood, and in order that the present contribution to the art may be appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important therefore, that claims be regarded as including such equivalent constructions insofar as they do not depart from the spirit and scope of the present invention.

Certain terminology and the derivations thereof may be used in the following description for convenience and reference only, and will not be limiting. For example, words such as “upward,” “downward,” “left,” and “right” refer to directions in the drawings to which reference is made unless otherwise stated. Similar words such as “inward” and “outward” refer to directions toward and away from, respectively, the geometric center of a device or area and designated parts thereof. Reference in the singular tense include the plural and vice versa, unless otherwise noted.

Turning to the figures, cat toy 10 is composed of hollow shell 11 defined by side walls 12 having a top 25 and a bottom 26 which, in its preferred iteration is in the shape of a cat. Top 25 is defined by head portion 13 below which is body portion 14 of the toy.

Within hollow shell 11 is power source 17 which is ideally a standard dry cell battery which can be removable from hollow shell 11 when replacement is required.

Battery 17 powers motor 18 whose on/off status can be controlled by switch 15 located on an exterior surface of hollow shell 11. When in the form of a cat, on/off switch 15 defines the nose of the cat in head region 13 which can be functionally connected to optional timer 16 such that motor 18 will be automatically switched off after the passage of a predetermined period of time. Ideally the motor will operate for 10 seconds, turn off for 10 seconds, resume for 10 seconds, etc.

Motor 18 powers drive pulley 19, connected to drive belt 31 which in turn drives clutch pulley 30 which then drives rotatable disk 20 at its geometric center 20a for selectively rotating disk 20. The rotatable disk is configured within opening 28 of hollow shell 11 and is made a part of the exterior surface of the toy as shown. When configured as a cat, rotatable disk 20 is situated at the bottom of body portion 14 opposite from head portion 13. Through the use of clutch pulley 30, disk 20 will stop rotating if the cat grabs and pulls excessively on string-like element 21.

String-like element 21 is appended to selectively rotatable disk 20 in a position offset from geometric center 20a. Thus, when motor 18, driving pulley 19 causes rotatable disk 20 to rotate, string-like element 21 also rotates about geometric center 20a but does so causing a haphazard random motion throughout its length which has been shown to addictively attract cats while maintaining their attention for extended periods of time.

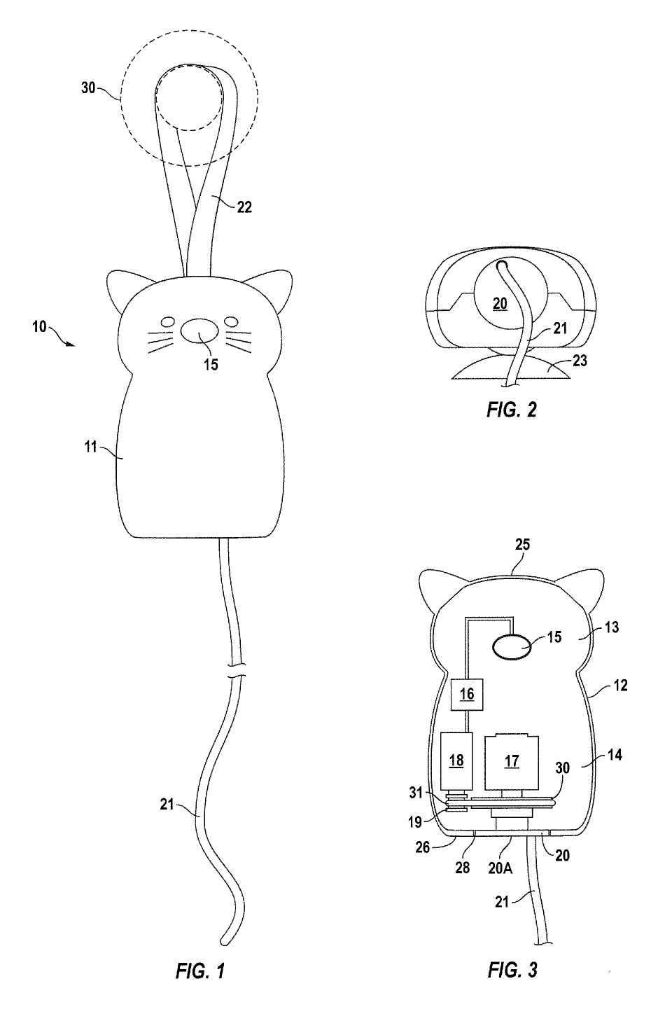

In a first embodiment, cat toy 10 can be provided with support 22 in the form of looped fabric for hanging pet toy 10 when in use. As noted, support 22 is appended to the top of hollow shell 12 generally above head portion 13 enabling pet toy 10 to hang from a projection such as door knob 30 shown in phantom in FIG. 1.

Alternatively, as a second embodiment, pet toy 10 can be removably appended to a vertical surface such as a door or wall through the use of suction cup 23 as best depicted in FIG. 2.

It should be readily apparent that what has been provided is a simple yet effective attractant-type pet toy uniquely configured to attract and maintain the attention of a pet cat without the need of human intervention. A cat owner can simply activate the toy by pressing upon switch 15 whereupon the toy will attract and maintain the attention of the pet without further intervention.

The above disclosure is sufficient to enable one of ordinary skill in the art to practice the invention, and provides the best mode of practicing the invention presently contemplated by the inventor. While there is provided herein a full and complete disclosure of the preferred embodiments of the invention, it is not desired to limit the invention to the exact construction, dimensions, relationships, or operations as described. Various modifications, alternative constructions, changes and equivalents will readily occur to those skilled in the art and may be employed as suitable without departing from the true spirit and scope of the invention. Such changes might involve alternative materials, components, structural arrangements, sizes, shapes, forms, functions, operational features or the like. Therefore, the above description and illustration should not be considered as limiting the scope of the invention, which is defined by the appended claims.

What is claimed is:

1. A cat toy comprising a hollow shell having a top and a bottom, a power source retained within said hollow shell for selectively powering a motor, a motor retained within said hollow shell having a drive pulley emanating therefrom, a selectively rotatable disk located at said bottom having a geometric center, said rotatable disk being driven by said motor causing it to rotate about its geometric center and configured within an opening in said hollow shell and made a part thereof, a string-like element appended to said selectively rotatable disk in a location radially offset from its geometric center and a switch for selectively turning on said motor, said switch being accessible on an exterior surface of said hollow shell.

2. The cat toy of claim 1 further comprising a support for hanging said cat toy when in use.

3. The cat toy of claim 2 wherein said support is appended to the top of said hollow shell such that when said support is used to hang said cat toy from a projection, said string-like element is caused to hang vertically from said selectively rotatable disk.

4. The cat toy of claim 3 wherein said projection is a door knob and said support comprises a looped element sized for extending over said door knob facilitating hanging said cat toy therefrom.

5. The cat toy of claim 1 further comprising a timer switch for powering off said motor after the passage of a predetermined period of time after selectively powering said motor.

6. The cat toy of claim 1 further comprising a clutch pulley driven by said motor for selectively stopping rotation of said rotatable disk.

7. A cat toy comprising a hollow shell in the shape of a cat having a head portion and body portion, a power source retained within said hollow shell for selectively powering a motor, a motor retained within said hollow shell having a drive pulley emanating therefrom, a selectively rotatable disk located at said body portion opposite said head portion and having a geometric center, said rotatable disk being driven by said motor causing it to rotate about its geometric center and configured within an opening within said hollow shell and made a part thereof and a string-like element appended to said selectively rotatable disk in a location radially offset from its geometric center and a switch for selectively turning on said motor, said switch being accessible on an exterior surface of said hollow shell.

8. The cat toy of claim 1 further comprising a support emanating from said head portion.

9. The cat toy of claim 7 wherein said support when used to hang said hollow shell from a projection results in said head portion positioned vertically above said body portion and said string-like element caused to hang vertically from said selectively rotatable disk.

10. The cat toy of claim 8 wherein said projection is a door knob and said support comprises a looped element sized for extending over said door knob facilitating hanging said cat toy therefrom.

11. The cat toy of claim 7 wherein said head portion is provided with an on/off switch positioned to simulate the nose of the cat.

12. The cat toy of claim 2 wherein said support comprises a suction cup appended to said hollow shell for removably attaching said pet toy to a vertical surface.

13. A cat toy comprising a hollow shell having a top and a bottom, a power source retained within said hollow shell for selectively powering a motor, a motor retained within said hollow shell having a drive pulley emanating therefrom, a drive belt driven by said drive pulley, a clutch pulley driven by said drive belt, a selectively rotatable disk located at said bottom having a geometric center being driven by said clutch pulley at said geometric center, a string-like element appended to said selectively rotatable disk in a location radially offset from its geometric center and a switch for selectively turning on said motor, said switch being accessible on an exterior surface of said hollow shell.
